(19) United States
(12) Patent Application Publication
(10) Pub. No.: US 2023/0169429 A1
(43) Pub. Date: Jun. 1, 2023

(54) REPURPOSING SYSTEM FOR ASSET MANAGEMENT

(71) Applicant: Microsoft Technology Licensing, LLC, Redmond, WA (US)

(72) Inventors: Aleksandr BITIUKOV, Bellevue, WA (US); Cheng-Che WU, Torrance, CA (US); Gregory L. WEBER, Sammamish, WA (US); Ranganathan SRIKANTH, Redmond, WA (US); Robert Aron DROLLINGER, Bellevue, WA (US); Daniel Stephen BUDIMIR, Annapolis, MD (US); David BEYER, Wisbaden (DE); Kesava VISWANATHAN, Sammamish, WA (US); Ashley DESIONGCO, Kent, WA (US)

(21) Appl. No.: 17/696,332

(22) Filed: Mar. 16, 2022

Related U.S. Application Data
(60) Provisional application No. 63/284,247, filed on Nov. 30, 2021.

(51) Int. Cl. G06Q 10/06; G06Q 30/02

(52) U.S. Cl. CPC G06Q 10/06315; G06Q 10/06393; G06Q 30/0202

(57) ABSTRACT

A repurposing system tracks tracking demand information associated with various types of used hardware components and also tracks characteristics of hardware inventory in use at one or more facilities. The tracked characteristics of the hardware inventory are used to generate a forecasted supply of used hardware components expected to arrive at a repurposing facility, and the tracked demand information is used to determine a collection of route options available to each used hardware component in the forecasted supply. A carbon equivalent savings is computed in association with each route option available to each hardware component and used to dynamically select one of the available route options for each hardware component.

### CROSS-REFERENCE TO RELATED APPLICATION

The present application claims priority to U.S. Provisional Application Serial No. 63/284,247, entitled “Predictive Warehouse Asset Management System” and filed on Nov. 30, 2021, which is hereby incorporated by reference for all that it discloses or teaches.

### BACKGROUND

Electronics repurposing centers receive diverse types of hardware in large quantities and perform tasks such as testing the hardware, harvesting spare parts, and disposing of or destroying parts that cannot be reused. These centers may receive shipments of returned materials and/or materials being retired or disposed of for various reasons, or even new or unused materials. Determining whether to repurpose each item, how each item is best repurposed, and what steps are needed to repurpose various items can be cumbersome and extremely complex given the many options that may be available in each case. Various types of repurposing can include, for example, reuse, recycling (e.g., general disposal v. responsible disposition), resale, parts harvesting, upgrading items for reuse, etc.

Some repurposing centers implement static rules and/or decision trees to perform intake and item repurposing. For example, a rule may provide that all servers generation X or newer are to be tested for reuse and resold if the test is successful. In addition, the decision of what to do with each item may be based on already-existing sales orders. For example, received hardware components may be assigned to existing sales orders upon arrival at the repurposing center. These methods lead to complex item-by-item assessments, low processing efficiencies, and no real methodical assurance that the chosen re-purpose for a given item is best in terms of cost savings, reduced waste, etc.

### BRIEF DESCRIPTIONS OF THE FIGURES

FIG. 1 illustrates an example repurposing system for enterprise asset management.

FIG. 2A illustrates aspects of another repurposing system for enterprise asset management.

FIG. 2B illustrates example metrics that may be computed to determine an overall cost recovery metric associated with each of various different route options that are discussed with respect to FIG. 2A.

FIG. 3 illustrates example sequences of actions that are dynamically generated by a repurposing system to fulfill routes assigned to various hardware components.

FIG. 4 illustrates an example floor plan of a repurposing center that may be used to prioritize a sequence of processing actions performed on a hardware component to fulfill an assigned route.

FIG. 5 illustrates an example processing device suitable for implementing aspects of the disclosed technology.

### SUMMARY

According to one implementation, a method disclosed herein provides for tracking demand information associated with various types of hardware components; tracking characteristics of hardware inventory in use at one or more facilities; and generating, based on the characteristics, a forecasted supply of used hardware components expected to arrive at the repurposing facility. The method further provides for determining, based on the tracked demand information, a collection of route options available for each used hardware component in the forecasted supply, where each one of the route options indicates a type of repurposing action. For each route option, a carbon equivalent savings is computed and used to dynamically select one of the route options for repurposing the hardware component.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. These and various other features and advantages will be apparent from a reading of the following Detailed Description.

### DETAILED DESCRIPTION

According to one implementation, the herein disclosed technology provides a system for managing warehouse assets that uses predictive assessments of future supply and dynamic assessments of current demand to pre-assign routes for incoming hardware. By example, the hardware may be computer hardware equipment, consumer or enterprise goods, appliances, waste streams of raw/bulk materials, automobiles, etc. Each assigned route is indicative of a specific type of repurposing action (e.g., reuse, repair, upgrade/refurbish, recycle, and/or responsible disposition of some or all components within the item). In one implementation, assigned routes further indicate a general destination for each item, such as whether the hardware item is being internally redistributed or sold to an external supplier. By example, a given route may provide for “repairing hardware for enterprise-external resale” or “repairing hardware for enterprise-internal redistribution.” Another example route may provide for harvesting specific components and disposing of the remaining (non-harvested) components. In the case where a hardware item is harvested for parts, a route may also be assigned to each harvested component such as “stock for sale to external suppliers” or “recirculate to enterprise facility X to stock as spare parts for server repairs.”

According to one implementation, the route assignments are executed based on sequences of dynamically-assigned actions that collectively facilitate the creation of organized stockpiles of repurposed hardware of various types that can, in turn, be assigned to fill existing orders (e.g., at the end of processing once the route-specific processing actions are completed). This is in contrast to existing asset management systems that assign routes to fill existing orders.

Some implementations of the disclosed technology provide for assigning routes to used hardware components (and/or subcomponents of such hardware) based on at least in part upon an assessment of certain value factors such as cost recovery/profits and environmental sustainability. For example, single or multivariable optimization techniques may be employed to select a route (or multiple routes for different subcomponents of the hardware) that provides a best trade-off of savings, environmental preservation, and/or other considerations. When items or subcomponents of an item are to be disposed of, there may exist many options available in each case. The herein disclosed technology provides a sophisticated software tool that quantifies value associated with different route options (e.g., different ways to repurpose an item) in ways that may allow an enterprise implementing the software tool to achieve a desired balance between environmental preservation and cost savings when assigning repurposing routes to used hardware items - a task that is cumbersome and extremely complex.

In still yet another implementation, a sequence of actions for fulfilling each selected route is dynamically determined based on characteristics of an individual repurposing center that receives the item. Dynamically-assigned actions may be prioritized within a given sequence based on considerations such as the physical layout of the repurposing center and/or the unique capabilities of the repurposing center. In still other implementations, techniques are employed to group items with identical routes to improve processing efficiency and to track such items as they move throughout a repurposing facility and are subjected to the various assigned processing actions.

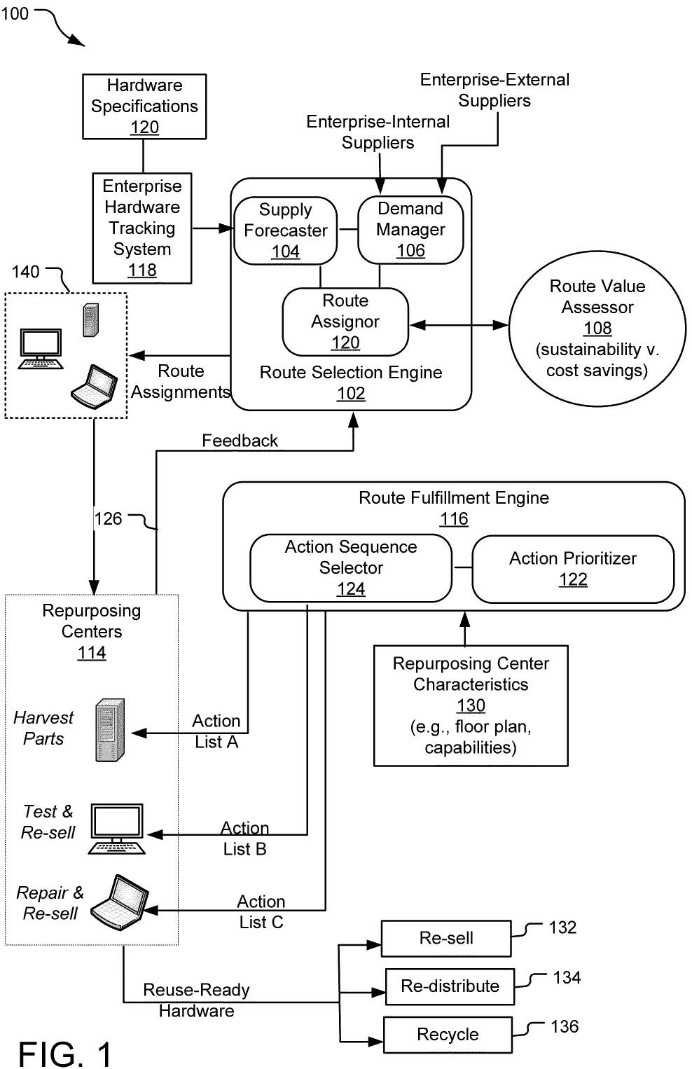

FIG. 1 illustrates an example repurposing system 100 for asset management. The system includes a route selection engine 102 and a route fulfillment engine 116 that may be understood as including software components or of a collection of software and hardware. The route selection engine 102 performs predictive analysis to assign routes to hardware items that arrive at various repurposing centers 114 within an enterprise system. By example, the enterprise system may include the repurposing centers 114 as well as a collection of enterprise-owned office buildings, datacenters, distribution centers, manufacturing facilities, storage warehouses, sales facilities, etc. (collectively referred to herein as “enterprise-owned facilities”). Hardware 140 sent to the repurposing centers may be diverse in type and include, for example, returned goods (e.g., goods sold to enterprise-external users and suppliers), as well as retired and/or defective hardware from enterprise-owned facilities, as well as newly purchased hardware from external suppliers.

The route selection engine 102 may include various submodules including a supply forecaster 104, a demand manager 106, and a route assignor 120. The supply forecaster 104 receives information from an enterprise hardware tracking system 118, for example. The enterprise hardware tracking system 118 manages hardware assets of the enterprise that are in active use at various facilities, such as by tracking characteristics such as hardware component type, time in-use, expected lifetime (e.g., hardware retirement policies of the enterprise), and/or planned actions for the hardware items that indicate when the hardware assets may be shipped to the repurposing center(s) 114 of the enterprise. For example, an enterprise policy may provide for upgrading employee laptops every 3 years and/or an operator may indicate that all servers in a given datacenter are going to be upgraded at a future time (e.g., December 2022). Collectively, this information is indicative of future hardware supply at the repurposing centers 114 (e.g., storage warehouses), including the specific hardware items that are expected to be received, predictive time of receipt for each hardware item, and the subcomponents existing within each hardware item that are available for harvest and reuse. Using this information, the supply forecaster 104 generates forecasts of incoming warehouse assets. In some implementations, the supply forecaster 104 receives real-time customer return information and is therefore able to add incoming customer-returned hardware to the forecasted supply.

A demand manager 106 tracks the current demand for different types of hardware items from various suppliers that receive goods from the repurposing centers 114. Depending on the type of enterprise, such demands may be generated by enterprise-internal suppliers and/or enterprise-external suppliers. For example, an enterprise-owned datacenter may request 100 sticks of RAM of a given type to be stocked as spare parts available for repairs to existing equipment on an as-needed basis. Alternatively, third-party (enterprise-external) suppliers may have pending purchase requests or sales orders waiting to be filled. The demand manager 106 performs frequent re-assessments of existing demand.

The supply forecasts generated by the supply forecaster 104 and the demand assessments generated by the demand manager 106 are provided to a route assignor 120 that, in turn, use the supply forecasts and demand assessments to identify one or more candidate routes for each incoming item in the forecasted supply. A route value assessor 108 performs an assessment of value associated with each of the identified routes. For example, a server may (among other options) be (1) resold as-is; (2) refurbished (upgraded) and re-sold; (3) re-used as-is within the enterprise; (4) upgraded and re-used within the enterprise; (5) harvested for parts; or (6) disposed of. All of these different routes are associated with different costs, benefits, and impacts to the enterprise, customers, or other parties, such as cost-savings and/or profit margins as well as different impacts on the environment.

According to one implementation, the route value assessor 108 computes, for each route option, a positive value metric that is based on both a carbon equivalent savings (sustainability) metric and a monetary value metric (e.g., in terms of cost savings or profit). The route value assessor 108 uses these two metrics to select the route with a highest total value, where value is based on a combination of estimated carbon equivalent savings and profit/cost savings. In another implementation, the route value assessor 108 identifies and selects a route option that jointly maximizes the carbon equivalent savings metric and the monetary value metric. Other implementations of the route value assessor 108 perform various types of multivariable optimization, some of which may be based on additional variable(s) in addition to or in lieu of those shown. In some implementations, the route value is determined based on the type of use (e.g., if the product could be directed to a high priority customer), the timeframe for processing the item for the repurpose, and other considerations.

In other implementations, routes are selected based on prioritization rules. For example, the tracked demand information may indicate that a first 100 components of a certain type are to be routed for inventory at a first facility and then, as soon as it is projected that this request is filled, routes are selected to fulfill other existing requests.

Based on the route value metric(s) provided by the route value assessor 108, the route assignor 120 assigns a route to each hardware item that is included in the forecasted supply. Notably, this route assignment may be based on serial number or other unique assignment means at a time before the hardware item physical arrives at one of the repurposing centers.

In one implementation, the demand manager 106 tracks the serial numbers of the forecasted incoming hardware items (e.g., those expected to arrive at a repurposing center at a future date) and associates those serial numbers and their routes with existing (open) supply requests. For example, an enterprise-internal supplier may have requested 50 servers with certain specifications to be reused in an enterprise-owned data center. As different servers in the forecasted supply are assigned for reuse along this route, the demand manager 106 tracks dynamic changes in the demand. For example, the demand manager 106 tracks the fact that 10 of 50 requested servers are expected to be met by the forecasted supply. The repurposing centers 114 provide feedback 126 to the route selection engine 102 that allows for dynamic updates to the tracked demand. If, for example, a server is tested but deemed defective and unusable for its associated pre-assigned route, the feedback 126 allows the demand manager to dynamically update demand information (e.g., to indicate that 9 of 50 are expected to be fulfilled by the forecasted supply).

The route selection engine 102 is, in some implementations, capable of changing, updating, deleting, or adding new routes to the system. In some cases, pre-assigned routes may be continuously recalculated by the route value assessor 108 and changed, on demand, to provide the optimal outcome responsive to receipt of new information concerning the respective hardware items. For example, a vehicle transporting the hardware items to a purposing center may receive GPS information indicating a road closure affecting the delivery. The vehicle may include an on-board controller that conveys such information, in real time, to the route selection engine 102. In response, the route selection engine 102 identifies alternate route options (e.g., alternate repurposing centers that may fulfill the route and/or routes better suited for the now delayed timeline), and the route value assessor 108 recomputes the conditions related to the road closure, new physical route to the repurposing center, to ensure the current route selection is still the route associated with the most optimal outcome given the re-computed route value metrics.

In some implementations, the route selection engine 102 assigns a “default” or “fallback” route, such as when available routes identified fail to meet predetermined value criteria (e.g., there is no compelling cost/benefit reason for choosing the identified routes). For example, a fallback or default route may be selected when there is no explicit demand and/or when hardware is received unexpectedly at a repurposing center. Selection of a default or fallback route may be dynamic or static for individual pieces of hardware or general classes of hardware. In cases where hardware is received unexpectedly at a repurposing center, the hardware may be assigned a default route or added to supply inventory of the supply forecaster 104 for dynamic route calculation.

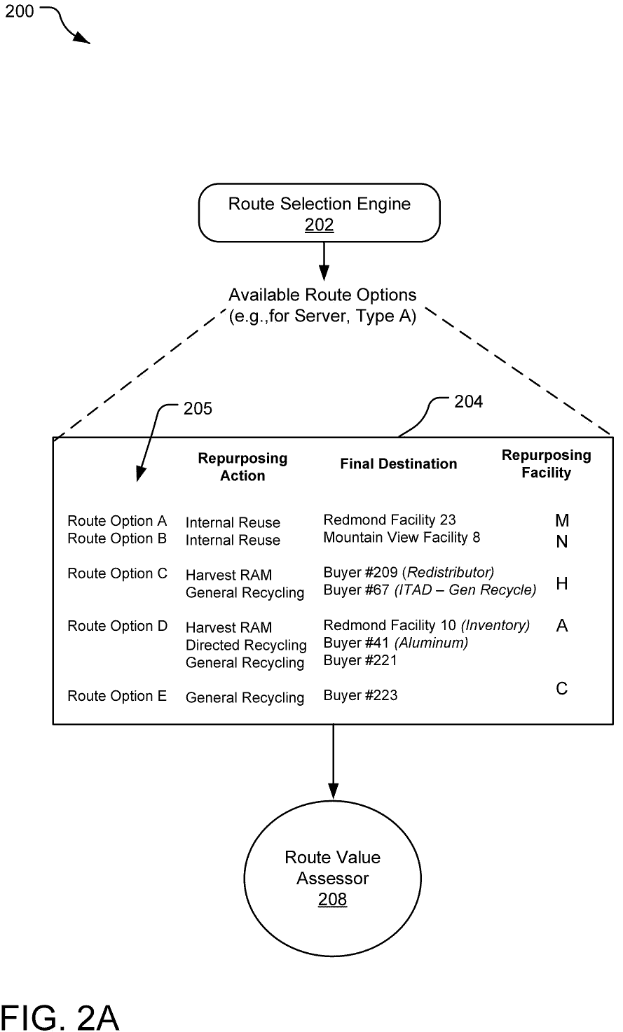

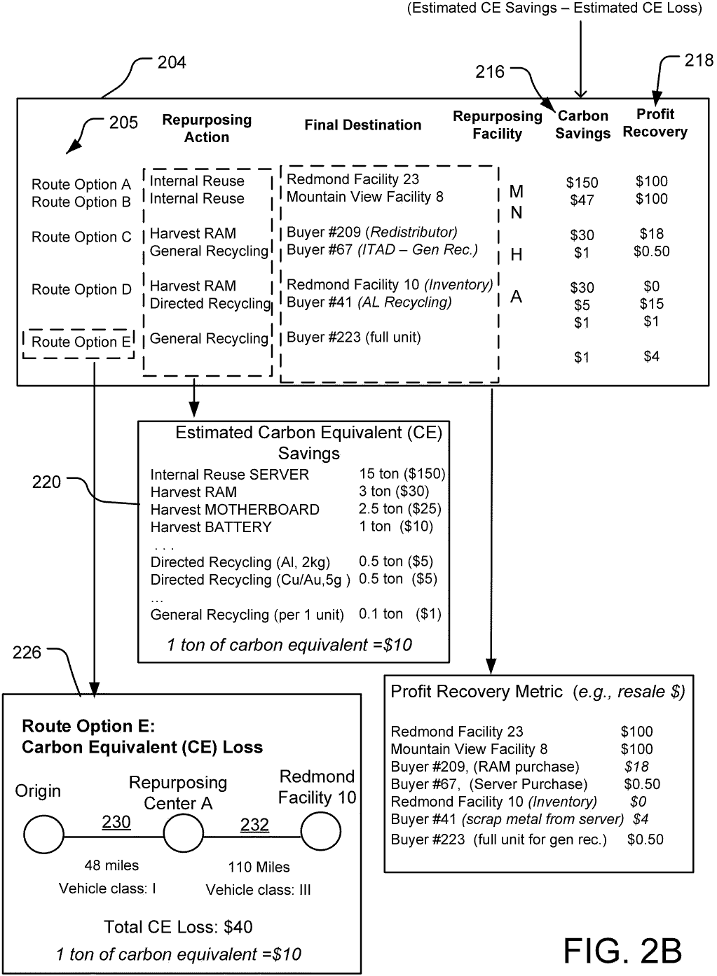

Notably, in some implementations, the route assigned to a particular hardware asset may depend upon the capabilities of a processing center that is preselected to receive and process the asset. For example, the enterprise managing the repurposing system 100 may place geographical limits on how far individual assets can travel to a repurposing center. For example, a certain asset may be pre-slated for processing at a specific repurposing center that is within a predefined geofence travel limit of the asset’s origination point. In this scenario, the route that is selected for the asset may be selected from route options that may be fulfilled by the capabilities of the associated repurposing center. For example, FIG. 2 below provides a scenario where one repurposing center lacks component testing capabilities and therefore is not used to fulfill “reuse” routes (instead, hardware that is harvested may be shipped off-site for testing and/or resale while the remaining components may be disposed of through general recycling (information technology asset disposition (ITAD)). In this example and a variety of other scenarios, the route itself may be selected based on the capabilities of the pre-assigned repurposing center .

When hardware items are pre-assigned a route as described above, the hardware items may be easily identified in association with the corresponding route when received at one of the repurposing centers. For example, a serial number may be scanned to retrieve a pre-assigned route. Upon intake at a given one of the repurposing centers 114, the route fulfillment engine 116 dynamically assigns a sequence of actions to be performed on the hardware item to fulfill the pre-assigned route.

The route fulfillment engine 116 may include an action sequence selector 124 and/or an action prioritizer 122. The action sequence selector 124 utilizes repurposing center characteristics 130 unique to each facility to dynamically generate the sequence of actions associated with each route and selects the specific sequence of actions that is to be associated with each hardware item (to fulfill its route). The action prioritizer 122 then determines a priority order with which the actions are to be executed within the selected sequence. In some implementations, the action sequence selector 124 determines some priority information - such as actions that are logically prioritized for a given reason (e.g., hardware is tested before being harvested). However, the action prioritizer 122 may further refine this sequence based on the physical capabilities of the repurposing center and/or the physical layout of the repurposing center, as discussed blow. For example, some repurposing centers may lack certain types of equipment and/or be otherwise capability limited - such as lacking certain testing equipment, repair capabilities, or test capabilities.

In some cases, priority is dictated by logical considerations. For example, it may logically make sense to test memory before or after harvesting it from a server depending on the testing equipment available. For certain types of operations, there may exist multiple sequencing options that are not bound by logical co-dependencies. In these cases, the action prioritizer 122 may utilize other considerations to prioritize actions within a given action sequence.

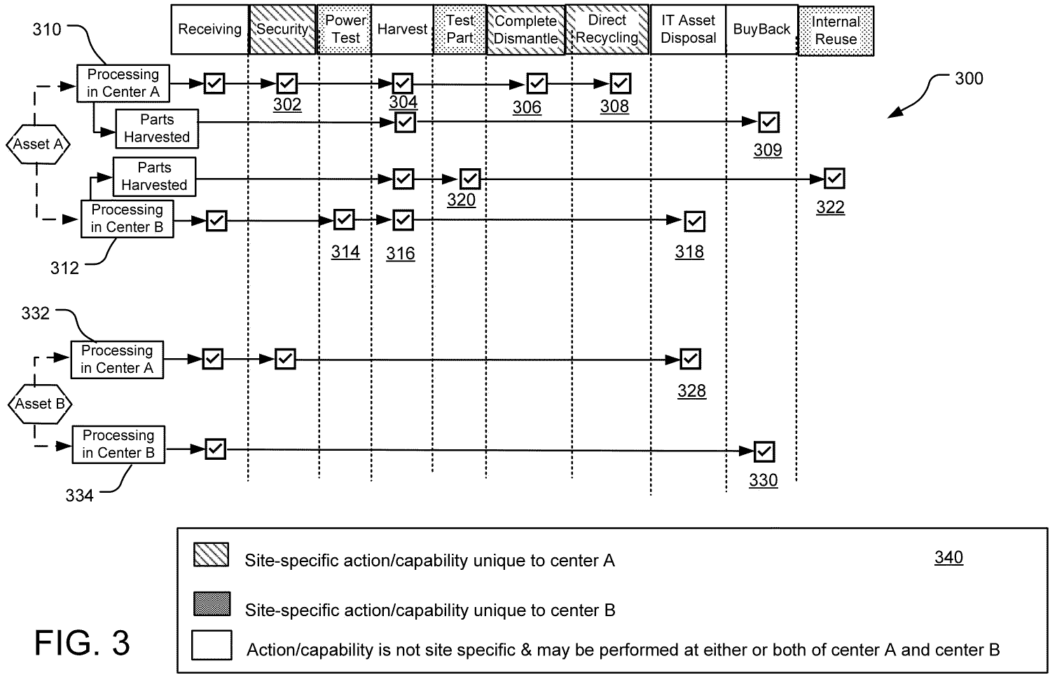

Notably, each action may be tied to a physical location (e.g., a given station) within the repurposing center. For example, there may exist different stations for testing, part harvesting, repairing, etc., which may all be different “logical stops” that the action prioritizer is aware of in association with specific actions. Each hardware item may be directed to a different specific logical stop within the repurposing facility after all other processing actions are performed. For example, there may exist a physical station (logical stop) for “reuse parts”, “buyback parts”, “recycling/disposal”, etc. In one implementation, the action prioritizer 122 determines an action sequence for each route that minimizes the total distance that the respective hardware item moves within the repurposing facility and/or the total number of “moves” within the repurposing facility that the hardware item is subjected to. In another implementation, the action prioritizer 122 determines an action sequence for each route that minimizes wait time. An example of this is shown and discussed below with respect to FIGS. 2 and 3.

In addition to the factors described above, the route selection engine 102, route fulfillment engine 116, and/or action sequence selector action 124 may also utilize characteristics of individual hardware assets and components in selecting the route, sequence, and priority (e.g., RAM size, server size/shape/power configuration, manufacturer, high security considerations, contractual obligations, or material composition).

Although not shown in FIG. 1, items may be grouped upon arrival at the various repurposing centers according to the pre-assigned routes. For example, all product serial numbers assigned the route of “harvest part X” may be physically packaged together in a crate and assigned a same sequence of actions such that the crate can be moved around to the different physical stops associated with each action, improving the total processing efficiency for the group.

In still another implementation, there exists a mobile application that simplifies the routing of tracking of each hardware item or component throughout its assigned sequence actions. For example, the mobile application may receive as input a scanned serial number and, in response, display the assigned route and the associated sequence of actions along with an indication of the current action in-progress and/or the next assigned action. Using the mobile application, an operator can indicate when a given action has been completed and easily determine the next action that the item is to be subjected to and the physical stop within the facility associated with that action.

Once each component has reached a final logical stop (physical station) associated with a last action in the sequence of actions for the associated route, the items are transported to serve the respective purposes associated with each route (e.g., purposes indicated in FIG. 1 include resale 132, re-distribution 134, and recycle/disposal 136. Within the repurposing center, the item can be transported to fulfill the route purpose (e.g., redistribute, recycle, or resell). For example, the above-described processes may result in one packaged crate of identically-refurbished servers that are slated for resale, another crate of identical hardware items that are to be sent to a particular facility within the enterprise, etc.

Items assigned to “re-sale” routes are, upon completion of the sequence of route actions, assigned to fill with open sales orders. Thus, route-based inventories are essentially created and used to fill orders. This is in contrast to traditional systems that initially associate items with specific sales orders and then design routes to fill each different respective order. Notably, the above-described operations dramatically streamline and simplify the processing of used hardware assets. Rather than moving individual items through routes individually designed to fill specific orders, the above methodology uses forecasted supply and existing demand to stock “inventories” of items, each inventory being a group of items assigned to a same route that can be moved and processed together to serve a same repurposing goal.

Although FIG. 1 illustrates an example end-to-end system, various implementations of the disclosed technology may implement fewer than all of the components shown in FIG. 1. For example, the route fulfillment engine 116 may be implemented in a system that uses different logical mechanisms to assign routes than that discussed above with respect to the route selection engine 102. In different implementations, the various subcomponents of FIG. 1 may be implemented in isolation and/or in different sub-combinations.

FIG. 2A illustrates aspects of another repurposing system 200 for asset management. A route selection engine 202 implements logic the same or similar to that discussed with respect to the route selection engine of FIG. 1 to identify route options 205 available to a particular used hardware component that is being tracked by an enterprise utilizing the repurposing system 200. In one implementation, the route selection engine 202 generates the route options 204 a based on inputs the same or similar to those discussed with respect to the route selection engine of FIG. 1. For example, by tracking demand information from various different types of hardware suppliers and available supply that has already been assigned to fill some of the existing demand, the route selection engine 202 identifies five different potential route options 205 (A-E) that are available for processing a used server of a particular type (e.g., Type A).

In one implementation, the route selection engine 202 identifies the route options 205 by utilizing a knowledge graph or relational database that stores tracked supply and demand information. The route selection engine 202 may further apply predefined heuristic rules to eliminate route options that are unreasonable for various reasons. For instance, certain repurposing centers may lack hardware to perform actions that are essential to fulfilling a given type of route while other repurposing centers may be located so far from the origin and/or final destination points of the associated route that that fulfillment of the route becomes impractical due to labor costs (e.g., driver time) and/or environmental impact (e.g., carbon emissions to fulfill the route).

Assume, for example, the route selection engine 202 determines that a repurposing center 200 miles away has the capability to ready a hardware component for a directed recycling action (e.g., a preferred type of recycling) while another repurposing center 10 miles away lacks the capability to ready the item for the directed recycling action but can, instead, ready the item for general recycling (e.g., a comparatively less environmentally-friendly type of recycling). In this case, the route selection engine 202 may eliminate the first route option because the addition of 190 miles or more to the transit distance contributes an environmental cost that outweighs the added environmental value that can be realized by performing directed recycling over general recycling. Using other heuristic rules such as this, impractical route options are eliminated, leaving the five options shown in table 204.

With reference to the table 204, a first route option (A) provides for the repurposing action “internal reuse” and indicates a particular facility that is to receive and reuse the item. In this example, the particular facility is internal to the enterprise and is located in Redmond, Washington. The route selection engine 202 selects a repurposing facility (e.g., “M”) to perform processing actions on the item that are associated with the route, e.g., processing actions such as destroying data stored on the item, testing the item, packaging the item with other like-routed items. In one implementation, the route selection engine 202 identifies and selects, for each route option, a repurposing facility that minimizes total travel distance of the hardware component throughout the period of time in which the route option is being fulfilled. For example, the repurposing center “M” may be selected from a group of available repurposing centers because the use of “M” mitigates a total travel distance or fuel consumption in the end-to-end transport of the server along the route (e.g., from an origin, to processing facility “M”, and then to Redmond Facility 23).

A second route option (B) in the table 204 provides for “internal reuse” and for transporting the server to another facility of the enterprise located in Mountain View, California.

A third route option (C) provides for harvesting RAM and using the harvested RAM to fulfill one unit of an outstanding bulk order for a particular external buyer. The third route option (C) also provides for transporting the remaining (e.g., non-harvested) server parts from the selected repurposing center (H) to a general recycling facility.

A fourth route option (D) in the table 204 provides for harvesting RAM and using the harvested RAM to stock an inventory need (e.g., spare parts) at a facility of the enterprise located in Redmond, Washington. The same route also provides for directed recycling of certain specified materials or subcomponents (e.g., aluminum).

As used herein, “directed recycling” refers a material-specific recycling option where it can be known, in advance, which materials are to be recycled and how they will be used. Directed recycling is typically material-specific; thus, fulfillment of a directed-recycling order may entail some disassembly of the hardware component, such as to separate components including different materials such as Cu, Au, Al, etc. For example, the directed recycling buyer listed in association with route (D) is one that purchases scrap aluminum for a particular product or industry. In contrast with “directed recycling,” the term “general recycling” is used herein to refer to general recycling of mixed electronic materials where it is not necessarily known in advance which specific materials are to be recycled or what purpose those recycled materials are to serve. For example, a general recycling center may be an IT asset distribution (ITAD) center that accepts whole units (e.g., servers) and/or components for recycling.

A fifth route option (E) in the table 204 provides for general recycling of the entire server at a general recycling facility (e.g., buyer 223).

In one implementation, information such as that discussed above with respect to the table 204 is input to a route value assessor 208. The route value assessor 208 computes certain metric(s) associated with each route option. In one implementation, the route value assessor dynamically computes an estimated carbon equivalent savings associated with each of the route options 205. In general, the estimated carbon equivalent savings estimates an environmental impact of the associated route option and may take into consideration various factors such as the repurposing action(s) associated with each route option, the type of hardware component, and the estimated quantity of carbon prospectively emitted in the fulfillment of the route option. For example, the estimated carbon equivalent savings for route option (C) may include the net sum of estimated carbon saved by reusing the RAM instead of throwing it away and by recycling the remaining parts instead of throwing them away.

In another implementation, the route value assessor 208 additionally computes a profit recovery metric associated with each route option where the profit recovery metric indicates, in terms of dollars or other currency, a cost that the enterprise recovers by selecting the associated route option. For example, the profit recovery metric for route option (C) may include the net sum of money that buyer #209 pays the enterprise for the harvested RAM and that buyer #67 is to pay for the general recycling materials.

In different implementations, the route value assessor 208 employs different parameter weighting schemes and optimization techniques compute an “overall cost recovery metric” for each route option, where the overall cost recovery metric is based on a consideration of both estimated profit recovery and estimated carbon savings. One example optimization technique is discussed below with respect to FIG. 2B.

FIG. 2B illustrates example metrics that the route value assessor 208 (of FIG. 2A) may compute to determine an overall cost recovery metric associated with each of the different route options (A-E) that are discussed above with respect to FIG. 2A. In FIG. 2B, an expanded version of table 204 includes the same information as discussed above and additionally includes a computed carbon equivalent savings 216 and a computed profit recovery metric 218 for each of the route options 205. In this example, the carbon equivalent savings 216 correlates with an estimated carbon emissions savings associated with selection of the route option. In some implementations, the carbon equivalent savings 216 may be adjusted to account for estimated carbon emissions (or monetary equivalent thereof) that occur as a result of the hardware component being transported to each of the various physical stops associated with the route option.

An example table 220 illustrates the estimated carbon equivalent savings associated with each different type of repurposing action that can be performed on the hardware component or its respective subcomponents (e.g., internal reuse, harvest, directed recycling, general recycling). In this table, a monetary value is assigned to a given unit of carbon emissions savings (e.g., 1 ton of carbon equivalent = $10). This exchange rate may be implementation-specific and in some cases, set by the enterprise, such as based on how much the enterprise prefers to value carbon savings relative to monetary profits.

The carbon equivalent savings associated with each repurposing action is specific to the hardware component in question. For example, the table 220 indicates that harvesting RAM saves 3 tons of carbon equivalent while harvesting a motherboard saves 2.5 tons of carbon equivalent. Likewise, the estimated carbon equivalent savings for the repurposing action “reuse” also depends on the type of item. For example, the route value assessor may determine a carbon emissions loss associated with manufacture and distribution of a new server (e.g., 15 ton) and utilize this value as the carbon emissions savings reaped by reusing the server rather than purchasing a new one. Alternatively, the estimated carbon emissions savings for a “reuse” repurposing action may be computed based on the estimated carbon emissions that are saved by not throwing the used server into a landfill. In yet still another implementation, estimated carbon savings for a “reuse” repurposing action is based on both (e.g., a sum of) the carbon emission saved by not manufacturing a new server and also not throwing a server into a landfill.

As further shown in the table 220, the estimated carbon equivalent savings of a directed recycling action depends on both the type and quantity of materials being recycled - both of which are specific to the hardware component that is being subjected to the repurposing route. For example, the route value assessor 208 may access catalog data and retrieve a carbon equivalent savings stored in association repurposing action (e.g., reuse, harvest, directed recycling, general recycling) and in association with the applicable hardware component or subcomponent(s) (e.g., the subcomponents of the hardware component being handled according to each different repurposing action).

In addition to determining the estimated carbon equivalent savings for each one of the different route options 205 (A-E), the route value assessor may further determine a carbon equivalent loss, as shown in table 226, based on transit considerations associated with the fulfillment of each of the different route options 205. For example, the table 226 illustrates that fulfillment of route option E entails transporting the hardware component along two different transit legs. A first transit leg 230 is 48 miles long and extends from a defined origin (e.g., an entity or facility previously utilizing the hardware component) to the selected repurposing center (C). A second transit leg 232 is 110 miles long and extends between the selected repurposing center (C) and the final destination of the hardware component (e.g., a general purpose recycling facility). In this example, the carbon equivalent loss for each leg of the route may depend on various factors such as the physical length of the leg (e.g., 48 miles), the type of road traveled along the leg (e.g., highways being more efficient on gas than rural roads), as well as the type of vehicle used to transport the item (e.g., the fuel-efficiency characteristics of the vehicle). In various implementations, the route value assessor accesses various data sources to determine some or all of the above-listed transit considerations and to compute the carbon equivalent loss for each of the route options 205.

Notably, the fulfillment of some the route options 205 may entail transporting different subcomponents to different end destinations. For example, a server may be transported to a repurposing center where different components are harvested and individually transported to different buyers. In these scenarios, the route value assessor may compute the carbon equivalent loss for each different transit leg (e.g., transit legs for the hardware component as a whole and also for the individually-transported subcomponents) and sum these values together to compute the carbon equivalent loss for the route.

In implementations that provide for computing the carbon equivalent loss associated with each route option (as shown by the table 226), the carbon savings equivalent for each route option may be adjusted by subtracting the carbon equivalent loss for the route option from the carbon equivalent savings that is determined for the route options as a whole.

In addition to computing the carbon savings equivalent, some implementations of the disclosed technology may additionally provide for computing a profit recovery metric (e.g., the profit recovery metric 218 shown with respect to table 220), where ethe profit recovery metric represents a monetary profit or cost savings that is realized by the enterprise as a result of selecting the associated route option. For example, reusing a server within the enterprise may save the enterprise the cost of buying a new server. Likewise, different buyers may offer different sums of money for different harvested subcomponents, recycling materials, etc.

In different implementations, the route value assessor employs different parameter weighting schemes and optimization techniques to compute an overall cost recovery metric in association with each route option. In one implementation, the overall cost recovery metric is based on a consideration of both a determined carbon equivalent savings for a route as well as the profit recovery metric computed for the route. If, for example, the carbon equivalent savings is determined in terms of dollars (e.g., as shown in the table 220) the route value assessor may select the route option that maximizes the sum of the carbon equivalent savings and the profit recovery metric (e.g., a single variable maximization of this sum). In still another implementation, the enterprise implementing the disclosed technology selects a weighting scheme that favors route options with particular characteristics, such as route options that provide for specific repurposing action(s), distribution to certain preferred buyers, and/or other factors.

In yet still another implementation, the cost value assessor applies a multi-variable optimization scheme such as mixed integer programming or multi-objective optimization to identify and select route options that satisfy enterprise-preferred criteria. For example, the enterprise may wish to select routes that provide a best trade-off between environmental sustainability and profit recovery. This may be achieved, for example, by identifying the route that jointly maximizes the carbon equivalent savings and the profit recovery metric associated with the route as a whole.

FIG. 3 illustrates example sequences of actions 300 that are dynamically generated by a repurposing system to fulfill routes assigned to various hardware components. For example, a route may be assigned to each hardware component in a manner the same or similar as that discussed above with respect to FIG. 1 or FIGS. 2A-2B. The hardware component is then received at a repurposing center, and a sequence of processing actions is dynamically generated with respect to the hardware component and the associated assigned route. For example, the route for each hardware item may be assigned by the route selection engine 102 of FIG. 1 per the same or similar methodology described above.

In one implementation, the sequence of actions dynamically assigned to each different hardware component depends upon characteristics of the repurposing center where the actions are performed. FIG. 3 specifically illustrates pairs of actions sequences that may be dynamically assigned, in the alternative, to each of two assets - Asset A and Asset B. These potential action sequences are determined, at least in part, based upon the characteristics and capabilities of the repurposing center that receives the respective asset.

In FIG. 3, Asset A represents a hardware component that has been preassigned to the route that provides for the repurposing action “harvest.” For example, asset A is a server with a RAM component that is to be harvested at the repurposing center. FIG. 3 illustrates a first sequence of processing actions (e.g., actions following processing block 310) that are dynamically assigned to asset A to fulfill the assigned route of “harvest” when asset A is to be processed at repurposing center A. In contrast, a second sequence of processing actions (e.g., actions following processing block 312) is dynamically assigned to asset A to fulfill the assigned route of “harvest” if asset A is to be processed at repurposing center B.

In the example illustrated with reference to the key 340, Repurposing Center A has certain capabilities that are different from the capabilities of Repurposing Center B. These different capabilities affect the sequences of actions that are dynamically selected for each incoming hardware asset at the given facility. For instance, Repurposing Center A has the capability to destroy data bearing devices and therefore subjects incoming hardware to a “security action,” during which data devices (hard drive disks (HDDs) and solid state drives (SSDs) are extracted from the hardware and destroyed. Repurposing Center B does not have the capability to destroy data bearing devices and therefore does not subject incoming assets to the security action.

Among further differences, Repurposing Center A has a recycling station with full dismantling capability (“Dismantle”), which allows for total dismantling of the assets into different types of recyclables. For this reason, Repurposing Center A supports “Direct Recycling,” which may be understood as material-specific recycling where it is possible to know, in advance, what it do be done with the recycled materials. Notably, Repurposing Center B lacks the dismantling capability and therefore does not include a dismantle station or subject assets or their respective components to the “direct recycling” station actions (e.g., packing, shipping to material-specific recycling centers). Instead, Repurposing Center B is limited to recycling of materials in whole units (such as entire servers) via a station entitled “ITAD” (information technology asset disposal).

Still in further addition to the differences discussed above, Repurposing Center B has also the further unique capability of performing power and part testing (e.g., at “PowerTest” station and “Test Part” station) while Repurposing Center A does not have power or component testing capabilities. In some repurposing centers, power and/or component testing may be a prerequisite action for an action “internal reuse” (preparing, storing, or shipping parts to be reused within the enterprise). For example, FIG. 3 illustrates an “internal reuse” action, which is available at Repurposing Center B and not Repurposing Center A (e.g., because unlike Repurposing Center A, Repurposing Center B center has the capability to test parts to ensure they are in suitable condition for recirculation). Since Repurposing Center A cannot perform power or parts testing, components processed at Repurposing Center A are disposed of through directed recycling or IT asset disposal, but not reuse.

Thus, through the action sequences illustrated in FIG. 3, a part can be harvested from the same asset and the remaining components disposed of in different ways that depend upon the facility’s capabilities. If asset A is assigned to a route that includes a “harvest” repurposing action and also assigned to be processed at Repurposing Center A, asset A is subjected to a sequence of actions including: a security action 302 for distribution of data bearing devices included in the hardware; a harvesting action 304 (e.g., harvesting RAM or other component); a dismantling action 306 (e.g., a complete dismantling of the hardware subcomponents at a recycling station); and a directed recycling action 308 whereby dismantled components are combined and sent to material-specific recycling centers. The part harvested at the harvesting action 304 is then subject to a buyback action 309, meaning that it is either shipped off to a specific buyer or, alternatively, stored in inventory and sold to a supplier later.

In contrast, if asset A is assigned to a route that includes the “harvest” repurposing action and is also assigned to be processed at Repurposing Center B, asset A is subjected to a different sequence of actions including a power testing action 314 and a harvesting action 316. The harvested component is subjected to a part testing action 320 and - following testing -further actions 322 to fulfill the end disposition of internal reuse. The further actions 322 may, for example, may entail repacking and redistributing the part to another facility within the enterprise. Hardware remaining after the harvesting action 316 (from which harvested parts have been removed) is provided at 318 to a third-party distributor for ITAD (information technology asset disposal), where the item may be prepared for reuse or responsibly recycled.

In addition to the example described above, FIG. 3 additionally illustrates sequences of processing actions following blocks 332, 334 for a second asset -Asset B. Asset B is, for example, a material or component that does not include any parts deemed worthy of harvesting. If Asset B is sent to Repurposing center A, Asset B is subjected to actions following block 332 that are effective to fulfill an end disposition route of ITAD 328, which again refers to shipping the hardware to a third party for reuse or responsible recycling. If Asset B is instead sent to Repurposing center A, Asset B is subjected to actions following block 332 that are effective to fulfill a disposition route of buyback 330, meaning that the asset is to be either shipped off to a specific buyer or, alternatively, stored in inventory and sold to a supplier later.

In the above example, it is notable that the original selection of the end disposition route for Asset B (e.g., buyback or ITAD) may be based on the availability of ITAD and/or buyback customers in the associated geographical regions of repurposing center A and Repurposing center B. For example, geofence limits on travel may dictate which repurposing center (A or B) receives Asset B and component demand within the geographical vicinity (e.g., country, region) of that repurposing center may influence the original selection of the route. As described above, individual capabilities of the different repurposing centers may influence the full sequence of actions that are to be performed at each facility.

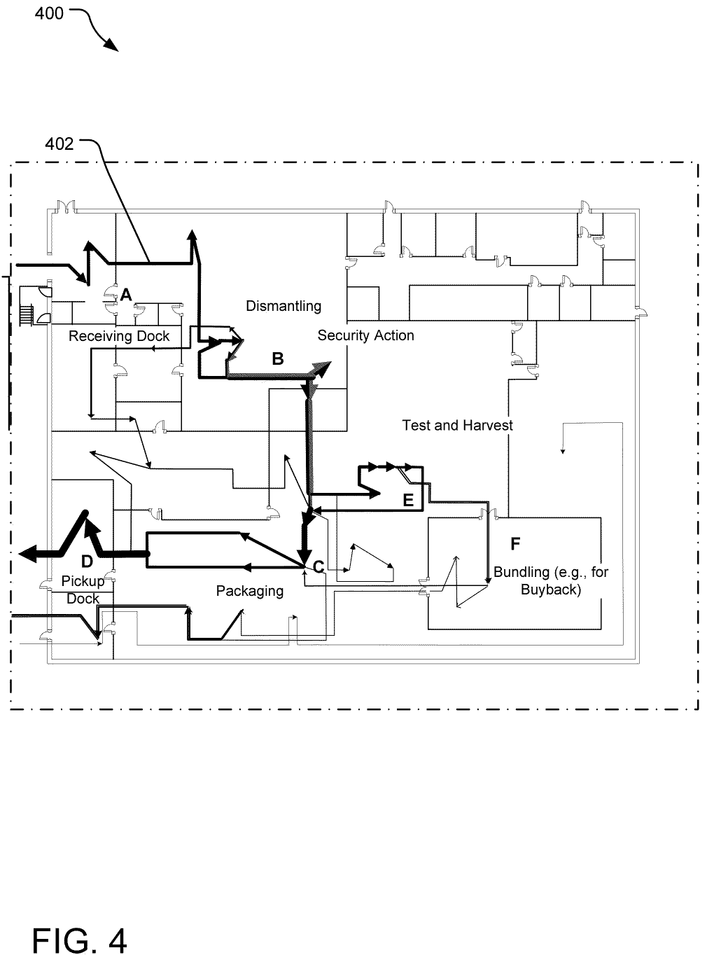

FIG. 4 illustrates an example floor plan 400 of a repurposing center that may be used to prioritize a sequence of processing actions performed on a hardware component to fulfill an assigned route. The sequence of processing actions (e.g., what tasks are performed) may be selected based on factors such as the route assigned, the nature of the hardware component, and the physical capabilities of the repurposing center that is to process the hardware component to fulfill the assigned route. The ordering of the sequence of processing actions may, in some implementations, be further affected by the floor plan 400 of the repurposing center.

The floor plan 400 indicates the existence and positions of various stations within the repurposing center where different types of tasks may be performed. For example, a large repurposing center may have 20 different stations each equipped to enable an operator to perform a single individual action while a smaller repurposing center may have only 4 stations that are multi-purpose and equipped to enable an operator to perform multiple actions (e.g., testing hardware and harvesting at a single station).

In one implementation, the route fulfillment engine uses the floor plan 499 of the repurposing center processing a hardware component to prioritize actions within the sequence of processing actions assigned to the hardware component (e.g., to fulfill the assigned route). For example, the actions may be prioritized so as to minimize the total number of moves between different physical stations in the repurposing center, to minimize the total time that the hardware component sits within the repurposing center (e.g., to efficiently perform multiple tasks consecutively at a same station when feasible), and/or to minimize the total distance that a hardware item is moved among the various stations during the execution of the assigned sequence of processing actions.

By example, FIG. 4 illustrates exemplary stations A, B, C, D, E, F, G where various processing actions are performed in a repurposing center. In FIG. 4, a path 402 illustrates how an individual hardware component may be assigned to move throughout the floor plan 400 according to a sequence of actions that have been prioritized by logic that mitigates a total travel distance of the hardware component and its various subcomponents without the repurposing center. In this example, mixed electronic goods are received at loading dock station A. The hardware item is moved from the loading dock station A to a dismantling station B where certain components are separated from one another, subjected to a security action (e.g., erasing or destroying data-bearing devices), and routed in different directions. If, for example, the hardware component is a server and the assigned route provides for harvesting RAM, station B may be used to separate the motherboard from the device casing. Certain subcomponent(s) separated at station B (e.g., the device casing) are moved to station C where they are packaged with other items that are to be recycled, and then moved on to station D for recycling pick-up. In the above example where the motherboard is removed from the device casing at station B, the motherboard is then independent moved (without the casing) to station E where a particular subcomponent (e.g., RAM) is then tested and harvested. The harvested subcomponent is moved to station F where it is temporarily stored and/or packaged with other like components that are, for example, to be shipped in units of a set quantity (e.g., 200 sticks of RAM) to fulfill incoming bulk orders. The parts remaining after the harvest at station E are routed to the recycling packaging area at station C and then moved to the pickup dock at station D.

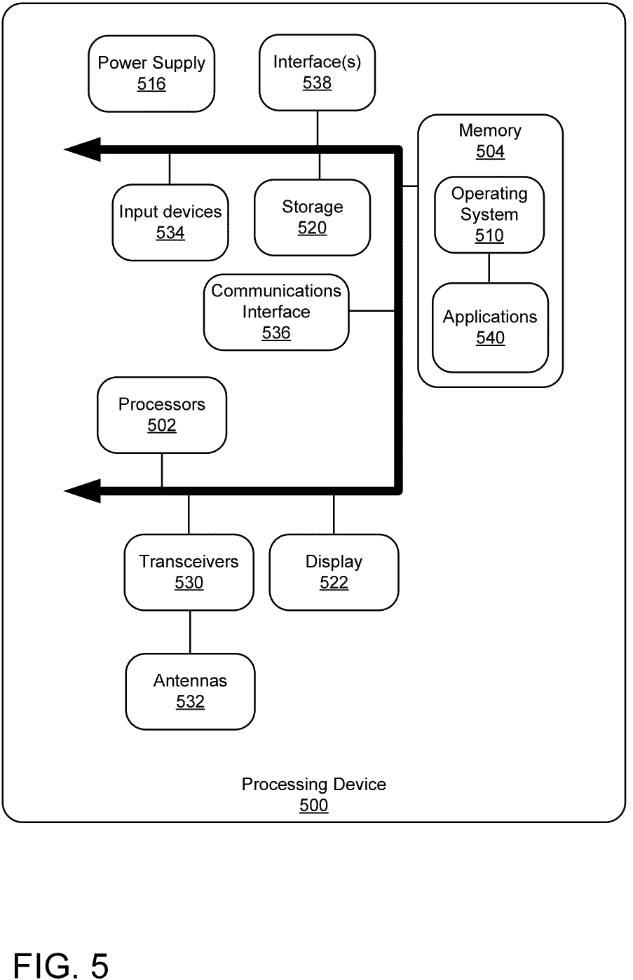

FIG. 5 illustrates an example schematic of a processing device 500 that may be suitable for implementing aspects of the disclosed technology. The processing device 500 includes a processing system 502 (e.g., a CPU and a USB controller), memory 504, a display 522, and other interfaces 538 (e.g., buttons). The memory 504 generally includes both volatile memory (e.g., RAM) and non-volatile memory (e.g., flash memory). An operating system 510, such as the Microsoft Windows® operating system, the Microsoft Windows® Phone operating system, or a specific operating system designed for a gaming device, resides in the memory 504 and is executed by the processor(s) 502, although it should be understood that other operating systems may be employed.

One or more applications 540, such as the route selection engine 102 of FIG. 1 or the route fulfillment engine 116 of FIG. 1 are loaded in the memory 504 and executed on the operating system 510 by one or more of the processors 502. Applications 540 may receive input from various input local devices (not shown) such as a microphone, keypad, mouse, stylus, touchpad, joystick, etc. Additionally, the applications 540 may receive input from one or more remote devices, such as remotely-located smart devices, by communicating with such devices over a wired or wireless network using more communication transceivers 530 and an antenna 532 to provide network connectivity (e.g., a mobile phone network, Wi-Fi®, or Bluetooth®). The processing device 500 further includes storage 520 and a power supply 516, which is powered by one or more batteries and/or other power sources and which provides power to other components of the processing device 500. The power supply 516 may also be connected to an external power source (not shown) that overrides or recharges the built-in batteries or other power sources.

The processing device 500 may include a variety of tangible computer-readable storage media and intangible computer-readable communication signals. Tangible computer-readable storage can be embodied by any available media that can be accessed by the processing device 500 and includes both volatile and nonvolatile storage media, and removable and non-removable storage media. Tangible computer-readable storage media excludes intangible and transitory communications signals and includes volatile and nonvolatile, removable and non-removable storage media implemented in any method or technology for storage of information such as computer readable instructions, data structures, program modules, or other data. Tangible computer-readable storage media includes RAM, ROM, EEPROM, flash memory or other memory technology, CDROM, digital versatile disks (DVD) or other optical disk storage, magnetic cassettes, magnetic tape, magnetic disk storage or other magnetic storage devices, or any other tangible medium which can be used to store the desired information, and which can be accessed by the processing device 500. In contrast to tangible computer-readable storage media, intangible computer-readable communication signals may embody computer readable instructions, data structures, program modules or other data resident in a modulated data signal, such as a carrier wave or other signal transport mechanism. The term “modulated data signal” means a signal that has one or more of its characteristics set or changed in such a manner as to encode information in the signal. By way of example intangible communication signals include wired media such as a wired network or direct-wired connection, and wireless media such as acoustic, RF, infrared, and other wireless media.

Some implementations may comprise an article of manufacture. An article of manufacture may comprise a tangible storage medium (a memory device) to store logic. Examples of a storage medium include one or more types of processor-readable storage media capable of storing electronic data, including volatile memory or non-volatile memory, removable or non-removable memory, erasable or non-erasable memory, writeable or rewriteable memory, and so forth. Examples of the logic include various software elements, such as software components, programs, applications, computer programs, application programs, system programs, machine programs, operating system software, middleware, firmware, software modules, routines, subroutines, operation segments, methods, procedures, software interfaces, application program interfaces (API), instruction sets, computing code, computer code, code segments, computer code segments, words, values, symbols, or any combination thereof. In one implementation, for example, an article of manufacture stores executable computer program instructions that, when executed by a computer, cause the computer to perform methods and/or operations in accordance with the described implementations. The executable computer program instructions may include any suitable type of code, such as source code, compiled code, interpreted code, executable code, static code, dynamic code, and the like. The executable computer program instructions may be implemented according to a predefined computer language, manner, or syntax, for instructing a computer to perform a certain operation segment. The instructions may be implemented using any suitable high-level, low-level, object-oriented, visual, compiled, and/or interpreted programming language.

(A1) An example computer-implemented method disclosed herein provides for tracking demand information associated with various types of used hardware components; tracking characteristics of hardware inventory in use at a facility; and generating, based on the characteristics of the hardware, a forecasted supply of used hardware components expected to arrive at a repurposing facility. Based on the tracked demand information, a collection of route options is determined for each used hardware component in the forecasted supply, where each one of the route options indicates a type of repurposing action. For each hardware component of the used hardware components in the forecasted supply, carbon equivalent savings is computed in association with each one of the route options available to the hardware component. The carbon equivalent savings metric is based on at least one characteristics of the hardware component and the type of repurposing action associated with the route option. Based on the carbon equivalent savings computed for each one of the route options available to the hardware component, one of the route options for the hardware component is dynamically computed.

The example method of A1 is beneficial because it allows for dynamic computation of and value assessment of many different routes for repurposing a hardware item, allowing an enterprise to make complex, item-specific environmentally-responsible decisions with relative ease.

(A2) In some implementations of A1, the method further includes determining a profit recovery metric associated with each route option of the collection of route options available to the hardware component, where the profit recovery metric quantifies a monetary recovery associated with the route option. The method also includes computing an overall recovery metric for each route option of the collection of route options available to the hardware component, where the overall recovery metric is based on both the determined carbon equivalent savings and the determined profit recovery metric for the route option. The dynamic selection one of the route options is further based on the overall recovery metric.

The example method of A2 is beneficial because it facilitates an assessment of both the monetary value (e.g., cost savings) as well as the environmental impact of each different possible repurposing route for hardware item, allowing an enterprise to base decisions on a tradeoff of company savings/profit and environmental sustainability.

(A3) In some further implementations of A1 and A2, dynamically selecting one of the route options further comprises dynamically selecting a route option that jointly maximizes the associated profit recovery metric and the associated computed carbon equivalent savings. The example method of A3 is beneficial because it allows and enterprise to maximize the tradeoff between cost savings and environmental sustainability when determining how to repurpose a hardware item.

(A4) In other implementations of A1-A3, determining the carbon equivalent savings associated with each of the route options further comprises retrieving, from a look-up table, a carbon equivalent savings associated with the type of repurposing action associated with the route option; computing a carbon equivalent loss attributable to end-to-end transit of the used hardware component incurred during prospective fulfillment of the route option; and computing the carbon equivalent savings by subtracting the carbon equivalent loss from the carbon equivalent savings. The method of A4 is beneficial because it provides for computing an environmental sustainability metric for a repurposing route that is based on not only the route selected but also the environmental resources expended in the potential fulfillment of the route.

(A5) In still other implementations of A1-A4, the carbon equivalent savings is greater when the type of repurposing action associated with the route option provides for a complete reuse of the used hardware component than when the type of repurposing type associated with route option provides for reuse of a subcomponent harvested from the used hardware component.

(A6) In still other implementations of A1-A5, the carbon equivalent savings is greater when the type of repurposing action associated with the route option provides for directed recycling than when the type of repurposing action of the route option provides for general recycling.

(A7) In yet still other implementations of A1-A6, the method further comprises receiving, at the repurposing facility, a used hardware component of the forecasted supply and an identification of a select route option assigned to the used hardware component. The physical layout and capabilities of the repurposing facility are determined along with a series of processing actions to be performed on the hardware component at select stations within the facility identified based on the layout and capabilities of the facility.

(A8) In still further implementations of A1-A7, dynamically determining the sequence of processing actions to be performed on the hardware component further comprises minimizing at least one of a number of stations that the hardware component is subjected to and minimizing a total physical distance that the hardware component is moved throughout the sequence of processing actions.

The methods of A7-A8 are beneficial because they provide for dynamically determining a sequence of actions for each repurposed item based on the specific route chosen and specific processing facility so as to maximize efficiencies and reduce overhead associated with fulfilling a given route.

In another aspect, some implementations provide systems for performing operations of any of A1-A8. In another aspect, some implementations include a computer-readable storage medium for storing computer-readable instructions. The computer-readable instructions, when executed by one or more hardware processors, perform any of the methods described herein (e.g., methods A1-A8).

The implementations described herein are implemented as logical steps in one or more computer systems. The logical operations may be implemented (1) as a sequence of processor-implemented steps executing in one or more computer systems and (2) as interconnected machine or circuit modules within one or more computer systems. The implementation is a matter of choice, dependent on the performance requirements of the computer system being utilized. Accordingly, the logical operations making up the implementations described herein are referred to variously as operations, steps, objects, or modules. Furthermore, it should be understood that logical operations may be performed in any order, unless explicitly claimed otherwise or a specific order is inherently necessitated by the claim language. The above specification, examples, and data, together with the attached appendices, provide a complete description of the structure and use of exemplary implementations.

What is claimed is:

1. One or more non-transitory computer-readable storage media storing computer-executable instructions for executing a computer process selecting and fulfilling repurposing routes for used hardware components, the computer process comprising:
tracking demand information associated with various types of used hardware components;
tracking characteristics of hardware inventory in use at a facility;
generating, based on the characteristics of the hardware, a forecasted supply of used hardware components expected to arrive at a repurposing facility;
based on the tracked demand information, determining a collection of route options available for each used hardware component in the forecasted supply, each one of the route options indicating a type of repurposing action;
for each hardware component of the used hardware components in the forecasted supply:
computing a carbon equivalent savings associated with each one of the route options available to the hardware component, the carbon equivalent savings metric being based on at least one characteristics of the hardware component and the type of repurposing action associated with the route option; and
based on the carbon equivalent savings computed for each one of the route options available to the hardware component, dynamically selecting one of the route options for the hardware component.

2. The one or more computer-readable storage media of claim 1, wherein the computer process further comprises:
for each hardware component of the used hardware components in the forecasted supply:
determining a profit recovery metric associated with each route option of the collection of route options available to the hardware component, the profit recovery metric quantifying a monetary recovery associated with the route option; and
computing an overall recovery metric for each route option of the collection of route options available to the hardware component, the overall recovery metric being based on both the determined carbon equivalent savings and the determined profit recovery metric for the route option, wherein dynamically selecting one of the route options is further based on the overall recovery metric.

3. The one or more computer-readable storage media of claim 2, wherein dynamically selecting one of the route options further comprises dynamically selecting a route option that jointly maximizes the associated profit recovery metric and the associated computed carbon equivalent savings.

4. The one or more computer-readable storage media of claim 1, wherein determining the carbon equivalent savings associated with each of the route options further comprises:
retrieving, from a look-up table, a carbon equivalent savings associated with the type of repurposing action associated with the route option; and
computing a carbon equivalent loss attributable to end-to-end transit of the used hardware component incurred during prospective fulfillment of the route option; and
computing the carbon equivalent savings by subtracting the carbon equivalent loss from the carbon equivalent savings.

5. The one or more computer-readable storage media of claim 4, wherein the carbon equivalent savings is greater when the type of repurposing action associated with the route option provides for a complete reuse of the used hardware component than when the type of repurposing type associated with route option provides for reuse of a subcomponent harvested from the used hardware component.

6. The one or more computer-readable storage media of claim 3, wherein the carbon equivalent savings is greater when the type of repurposing action associated with the route option provides for directed recycling than when the type of repurposing action of the route option provides for general recycling.

7. The one or more computer-readable storage media of claim 1, wherein the computer process further comprises:
receiving, at the repurposing facility, a used hardware component of the forecasted supply and an identification of a select route option assigned to the used hardware component;
determining at least one of a physical layout and capabilities of the repurposing facility, the physical layout including a plurality of stations with equipment for performing dedicated actions;
dynamically determining a sequence of processing actions to be performed on the hardware component at select stations of the plurality of stations based on the determined physical layout or capabilities, the sequence of processing actions effective to fulfill the route option selected for the hardware component.

8. The one or more computer-readable storage media of claim 7, wherein dynamically determining the sequence of processing actions to be performed on the hardware component further comprises:
minimizing at least one of a number of stations that the hardware component is subjected to and minimizing a total physical distance that the hardware component is moved throughout the sequence of processing actions.

9. A system for selecting and fulfilling repurposing routes for used hardware components, the system comprising:
memory;
a processing system;
a route selection engine stored in the memory and executable by the processing system to:
track demand information associated with various types of used hardware components;
track characteristics of hardware inventory in use at a facility;
generate, based on the characteristics of the hardware, a forecasted supply of used hardware components expected to arrive at a repurposing facility;
based on the tracked demand information, identify a collection of route options available for each used hardware component in the forecasted supply, each one of the route options being associated with a different type of repurposing action;
a route value assessor stored in the memory any executable by the processing system to:
compute a carbon equivalent savings associated with each route option of the collection of route options available to a hardware component in the forecasted supply, the carbon equivalent savings being based on at least one characteristics of the hardware component and the type of repurposing action associated with the route option, wherein the route selection engine selects one of the available route options for the hardware component based on the carbon equivalent savings computed in association with each of the available route options.

10. The system of claim 9, wherein the route selection engine is further executable to:
determine a profit recovery metric associated with each route option in the collection of route options available to the hardware component, the profit recovery metric quantifying a monetary recovery associated with the route option; and
compute an overall recovery metric for each route option in the collection of route options available to the hardware component, the overall recovery metric being based on both the determined carbon equivalent savings and the determined profit recovery metric for the route option, wherein the route selection engine selects the route option for the hardware component based on the overall recovery metric computed in association with each of the route options available to the hardware component.

11. The system of claim 10, wherein the route selection engine selects a route option that jointly maximizes the associated profit recovery metric and the associated carbon equivalent savings.

12. The system of claim 9, wherein the route selection engine is further executable to:
retrieve, from a look-up table, an estimated carbon equivalent savings associated with the type of repurposing action associated with a select route option of the collection of route options available to the hardware component; and
compute an estimated carbon equivalent loss attributable to end-to-end transit of the used hardware component incurred during prospective fulfillment of the route option; and
compute the carbon equivalent savings by subtracting the estimated carbon equivalent loss from the estimated carbon equivalent savings.

13. The system of claim 9, wherein the carbon equivalent savings is greater when the type of repurposing action associated with the route option provides for a complete reuse of the used hardware component than when the type of repurposing type associated with route option provides for reuse of a subcomponent harvested from the used hardware component.

14. The system of claim 9, wherein the carbon equivalent savings is greater when the type of repurposing action associated with the route option provides for directed recycling than when the type of repurposing action of the route option provides for general recycling.

15. The system of claim 9, further comprising:
a route fulfillment engine stored in the memory and executable by the processing system to:
determine at least one of a physical layout and capabilities of the repurposing facility that performs intake on a hardware component in the forecasted supply, the physical layout including a plurality of stations with equipment for performing dedicated actions;
dynamically determine a sequence of processing actions to be performed on the hardware component at select stations of the plurality of stations based on the determined physical layout or capabilities, the sequence of processing actions effective to fulfill the route option selected for the hardware component.

16. The system of claim 15, wherein the route fulfillment engine is further executable to dynamically determine the sequence of processing actions to be performed on the hardware component by:
performing an optimization that minimizes at least one of a number of stations that the hardware component is subjected to and minimizing a total physical distance that the hardware component is moved throughout the sequence of processing actions.

17. A method for routing used hardware components received at a repurposing facility, the method comprising:
tracking demand information associated with various types of used hardware components;
tracking characteristics of hardware inventory in use at a facility;
generating, based on the characteristics of the hardware, a forecasted supply of used hardware components expected to arrive at the repurposing facility;
based on the tracked demand information, determining a collection of route options available for each used hardware component in the forecasted supply, each one of the route options indicating a type of repurposing action;
for each hardware component of the used hardware components in the forecasted supply:
computing a carbon equivalent savings associated with each route option of the collection of route options available to the hardware component, the carbon equivalent savings being based on at least one characteristics of the hardware component and the type of repurposing action associated with the route option; and
based on the carbon equivalent savings computed for each route option of the collection of route options available to the hardware component, dynamically selecting one of the route options for the hardware component.

18. The method of claim 17, wherein the computer process further comprises:
for each hardware component of the used hardware components in the forecasted supply:
determine a profit recovery metric associated with each route option of the collection of route options available to the hardware component, the profit recovery metric quantifying a monetary recovery associated with the route option; and
computing an overall recovery metric for each route option of the collection of route options available to the hardware component, the overall recovery metric being based on both the determined carbon equivalent savings and the determined profit recovery metric for the route option, wherein dynamically selecting one of the route options is further based on the overall recovery metric.

19. The method of claim 18, wherein dynamically selecting one of the route options further comprises dynamically selecting a route option that jointly maximizes the profit recovery metric and the carbon equivalent savings.

20. The method of claim 17, wherein determining the carbon equivalent savings associated with each of the route options further comprises:
retrieving, from a look-up table, an estimated carbon equivalent savings associated with the type of repurposing action associated with the route option; and
computing an estimated carbon equivalent loss attributable to end-to-end transit of the used hardware component incurred during prospective fulfillment of the route option; and
computing the carbon equivalent savings by subtracting the estimated carbon equivalent loss from the estimated carbon equivalent savings.
